(19) United States
(12) Patent Application Publication
(10) Pub. No.: US 2011/0062834 A1
(43) Pub. Date: Mar. 17, 2011

(54) Enclosure for Residential and Commercial Hydrants

(75) Inventors: William T. Ball, Colorado Springs, CO (US); William L. Carlson, Elbert, CO (US)

(73) Assignee: WCM INDUSTRIES, INC., Colorado Springs, CO (US)

(21) Appl. No.: 12/560,721

(22) Filed: Sep. 16, 2009

(51) Int. Cl. A47F 5/08; E05B 65/46; A47B 96/06

(52) U.S. Cl. 312/215; 312/242; 312/245

(57) ABSTRACT

An enclosure for protecting and concealing a hydrant is provided. More specifically, the enclosure includes a box for integration into the wall and a replaceable fascia interconnected thereto. The fascia receives a door that is selectively opened and closed to expose the hydrant stored therein. In operation, the fascia and associated door may be removed and/or replaced without having to remove the entire box and hydrant.

### FIELD OF THE INVENTION

Embodiments of the present invention are generally related to an enclosure for concealing and protecting a hydrant.

### BACKGROUND OF THE INVENTION

Protective enclosures that conceal and protect hydrants are common and are usually incorporated into interior and exterior walls of a building. To provide access to an enclosed hydrant, a hingedly interconnected door, which may be selectively locked, is usually included. Enclosures are made in various sizes and shapes and are adapted to accommodate single or dual handled hydrants. Enclosures conceal hydrants that are often located in rooms that require continuous maintenance, such as a public bathroom. One drawback of prior art enclosures is that they must usually be replaced after painting operations. Enclosures of the prior art are very difficult to replace since the enclosures are often rigidly mounted to the wall and the hydrants requiring removal and reconnection. Further, keys that are used to open locks associated with the doors are often lost. Thus, maintenance individuals often pry and damage the door to gain access to the hydrant, thereby requiring replacement of the door and/or lock to ensure that the door can be later locked and/or closed properly. Unfortunately, replacement of the door entails removal of the entire enclosure and often the hydrant, which increases labor and costs.

Thus it is a long felt need to provide an enclosure for concealing and protecting a hydrant that includes a door that is easily replaced if it is to become covered with paint, damaged, or otherwise unusable.

### SUMMARY OF THE INVENTION

It is one aspect of the present invention to provide a protective enclosure for concealing and protecting a hydrant. The enclosure of one embodiment of the present invention includes a box having a top panel, bottom panel, side panels and a rear panel. The box (or “enclosure” or “receptacle”), and associated closure member, i.e., “door”, may be any shape, i.e., circular, square, rectangular, etc. The top panel, bottom panel, and side panels, define an edge with a lip extending therefrom that is adapted to receive a removable fascia. The facia may be repeatably removed and replaced easily at will. The box may include at least one drain hole that allows fluid to drain therefrom. In addition, a door is hingedly, or otherwise, associated with the fascia. For example, the door may be associated to the facia by way of sliding engagement, hook/loop connective structures, threaded engagements, snapping members, etc. One embodiment of the present invention is directed to an improved enclosure that includes a removable fascia that provides a location for interconnection of a hinged door, wherein the fascia and associated door may be easily removed as opposed to requiring the removal of the entire enclosure structure. One of skill in the art will appreciate that more than one door may be employed.

In operation, to replace a door, the fascia is removed and replaced. Embodiments of the present invention have the advantage of not requiring the removal of the entire enclosure from the wall to which it is interconnected. Although a box having an extending lip is provided, one skilled in the art will appreciate that other ways of replaceably interconnecting the fascia to the box are also contemplated without departing from the scope of the invention. For example, the fascia can be interconnected to the top panel, bottom panel and side panels via screws, bolts, adhesives, magnets, chips, latches, tongue and groove interconnections, or other similar interconnection mechanisms.

It is yet another aspect of the present invention to facilitate replacement of the enclosure wherein maintenance personnel are only required to replace the fascia, not the entire enclosure. The fascia as contemplated may be made of any material commonly used in constructing enclosures and may receive any appearance with respect to color, for example, to sufficiently blend in with paint or other surface texture of the surrounding walls. Further, the fascia may possess its own individual color and/or surface texture to more succinctly blend in to surfaces to which the enclosure is associated, such as an outdoor building surface, i.e., brick. By providing a system having a replaceable fascia, sufficient cost savings are appreciated. Further, embodiments of the present invention are less wasteful since the existing box that is positioned in the wall can be reused.

It is another aspect of the present invention to provide an enclosure that can be scaled in size. More specifically, it is contemplated that embodiments of the present invention be scalable to receive hydrants of many shapes, sizes, shut offs, and styles, such as those with a plurality of knobs for selective delivery of hot and cold water.

It is still yet another aspect of the present invention to provide a door that is adapted to receive lettering and or symbols. More specifically, often the nature of the item stored within the enclosure is written on the door, often for safety reasons. Accordingly, it is contemplated that the door be able to receive embossed, painted, or otherwise associated letters and/or symbols. The door of some embodiments of the present invention includes features that maintain the door in an open position. The door of some embodiments of the present invention are spring loaded that helps maintain the door in a closed position.

It is another aspect of the present invention to provide a fascia and door that are made of any common rigid material, such as metal, plastic or any similar type of material. Further, the box may be designed to be modifiable to accommodate penetrations related to the concealed hydrant. For example, the rear panel may include portions that may be punched out, cut or drilled through to accommodate another hydrant. It is envisioned that the fascia and door may be painted or made in any color that is suitable to match the surrounding wall or other building surface to which the enclosure is associated.

It is another aspect of some embodiments of the present invention to provide an enclosure having a door that is hingedly interconnected to the fascia. The doors contemplated are adapted to remain open if required and/or be easily removable for replacement or for access to the hydrant stored therein within the enclosure. Further, the door may be employed that is completely removable from the fascia. The door may be slidingly interconnected to the frame, e.g., similar to a garage door.

The top panel, the bottom panel and/or the at least one of the side panels may include a depth indicator. More specifically, when associating an enclosure with a building surface having a non-continuous surface, i.e., stone, it is desirable to offset the enclosure to accommodate the exterior building surface. The depth indicator will help locate the enclosure during construction by identifying the offset required.

Thus it is one aspect of the invention to provide a substantially rectangular housing for protecting a hydrant or other fluid delivery device that has four sides and a rearward portion that has an aperture sized to accept a pipe adapted for connection with the hydrant. The four sides each have a length and width and an exterior surface and an interior surface and at least one supporting structure associated on each of the four sides, wherein the supporting structures extends from the rearward portion along the width of each side. This embodiment also includes a substantially rectangular faceplate adapted to reversibly connect to the housing and includes a central aperture sized to permit an adult human hand to pass therethrough. Further, a movable cover is associated with the faceplate and is movable from a first closed position to a second open position, whereby when in the second open position, a human hand can access the hydrant. Depth indicia may also be provided on the exterior of the four sides that is spaced from the exterior surface of at least one of the four sides.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is an exploded perspective view of one embodiment of the present invention;

FIG. 2 is a perspective view of a fascia of one embodiment of the present invention;

FIG. 3 is a front elevation view of FIG. 2;

FIG. 4 is a left elevation view of FIG. 2;

FIG. 5 is a door of one embodiment of the present invention;

FIG. 6 is an unexploded perspective view of FIG. 1;

FIG. 7 is a front elevation view of FIG. 6;

FIG. 8 is a left elevation view of FIG. 6;

FIG. 9 is a top plan view of FIG. 6;

FIG. 10 is a cross-sectional view of FIG. 6;

FIG. 11 is a perspective view similar to that of FIG. 6 shown with the door in an open position;

FIG. 12 is a front elevation view of FIG. 11, wherein the door is shown in an open position;

FIG. 13 is a left elevation view of FIG. 11;

FIG. 14 is a top elevation view of FIG. 11; and

FIG. 15 is a cross-sectional view of FIG. 11.

FIG. 16 is an exploded perspective view of another embodiment of the present invention;

FIG. 17 is a perspective view of a fascia of another embodiment of the present invention;

FIG. 18 is a front elevation view of FIG. 17;

FIG. 19 is a left elevation view of FIG. 17;

FIG. 20 is a perspective view of a door of another embodiment;

FIG. 21 is an unexploded perspective view of FIG. 16;

FIG. 22 is a front elevation view of FIG. 21;

FIG. 23 is a left elevation view of FIG. 21;

FIG. 24 is a top plan view of FIG. 21;

FIG. 25 is a cross-sectional view of FIG. 22;

FIG. 26 is a perspective view of FIG. 21 shown with the door in an open position;

FIG. 27 is a front elevation view of FIG. 26;

FIG. 28 is a left elevation view of FIG. 26;

FIG. 29 is a top plan view of FIG. 26; and

FIG. 30 is a cross-sectional view of FIG. 27.

To assist in the understanding of the present invention the following list of components and associated numbering found in the drawings is provided herein:

| # | Component |
|---|---|
| 2 | Enclosure |
| 6 | Hydrant |
| 10 | Box |
| 14 | Fascia |
| 18 | Door |
| 22 | Top panel |
| 26 | Bottom panel |
| 30 | Side panel |
| 34 | Rear panel |
| 38 | Lip |
| 40 | Ribs |
| 42 | Boss |
| 46 | Plate |
| 50 | Screw |
| 54 | Pin |
| 58 | Lock |
| 62 | Valve |
| 66 | Hole |
| 70 | Hinge plate |
| 74 | Aperture |
| 78 | Tab |
| 84 | Slot |
| 88 | Depth gauge |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

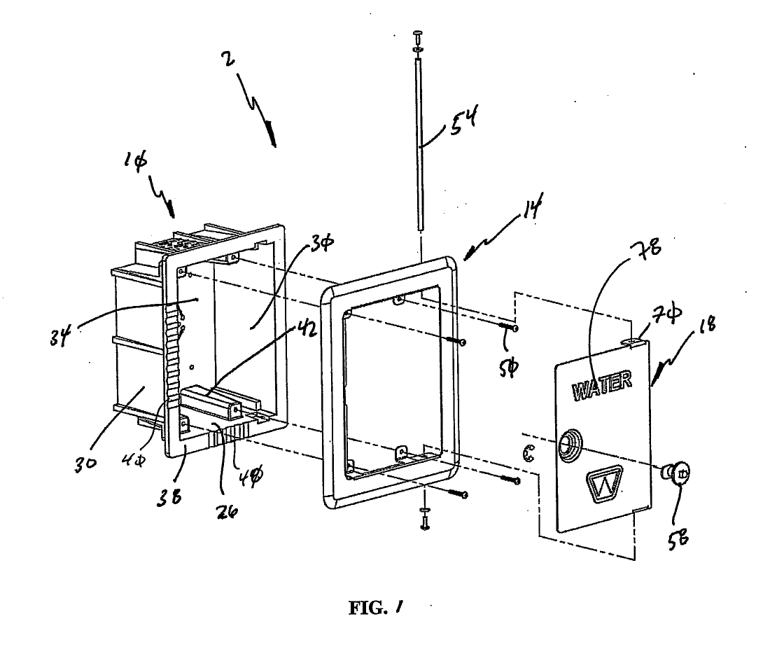

Referring now to FIGS. 1-30, an enclosure 2 for the receipt of a hydrant 6 is shown. The enclosure 2 of embodiments of the present invention generally includes a box 10 that is adapted to recess into a wall or other building surface. The box 10 receives a fascia 14 and associated door 18. In operation, the fascia 14 can be removed from the box 10 to be replaced, thereby maintaining the box 10 within the wall or other building surface which saves costs, time and reduces waste. Embodiments of the present invention include no gaps as commonly found on prior art stainless steel boxes.

Referring now specifically to FIGS. 1-15, a vertically oriented enclosure 2 is shown wherein the door 18 opens in the horizontal plane. The enclosure 2 is comprised of a box 10 having a top panel 22, bottom panel 26, and side panel 30 and rear panel 34. One of skill in the art will appreciate that other shapes may be employed without departing from the present invention. The top panel 22, bottom panel 26, and side panels 30 define an edge with an outwardly extending lip 38 interconnected thereto. The lip 38 may include a series of ribs 40 that facilitate the drainage of fluid from within the box 10 if the hydrant 6 leaks. The box 10 also includes a plurality of bosses 42 integrated into at least one of the top panel 22 and bottom panel 26. The fascia 14 includes plates 46 extending therefrom that engage the bosses 42 of the box 10. Preferably, a plurality of screws 50 is used to interconnect the fascia 14 to the box 10. One skilled in the art will appreciate that other ways of interconnecting the fascia 14 to the box 10 are contemplated, such as snap fit, an adhesive, etc., without departing from the scope of the invention. The door 18 is rotatably interconnected to the fascia 14 via a pin 54 that engages the top panel 22 and the bottom panel 26. The door 18 may also possess a lock 58 that cooperates with the fascia 14 to maintain the door 18 in a closed position.

Referring now to FIGS. 11-15, the enclosure 2 is shown in an open position wherein the door 18 is located away from the box 10. Here, the box is of a depth of sufficiently accommodate a hydrant 6 with an interconnected valve 62. The fascia 14, as described above, is interconnected to the box 10 via a screw 50 that sandwiches a plate 46 between its head and the boss 42. The box 10 is interconnected to a building structure via a plurality of fasteners that are received in holes associated with the rear panel of the box 10. Further, the door 18 is hingedly interconnected by way of the pin 54, screw, bolt, rivet, or other mechanism, wherein a hinge plate 70 of the door 18 cooperates with the pin 54 to allow rotation of the door 18 relative to the box 10. The door 18 also includes a lock 58 that is associated with the fascia 14.

In operation, in order to replace the fascia 14, one would simply actuate the lock 58 (if applicable) and open the door 18 or otherwise pry the door 18 from the fascia 14 (if it is damaged, for example), remove the screws 50 and remove the fascia 14 from the box 10. Next, a new fascia may be interconnected to the box 10 via the screws 50. The box 10 remains in place and does not need to be replaced, thereby saving time, cost and reducing waste.

Referring now to FIGS. 16-30, yet another embodiment of the present invention is shown that includes a door 18 that opens in the vertical plane. The hydrant 6 shown herein is situated such that the handle thereof is positioned to the side of the valve, for example. The construction of this embodiment of the present invention is very similar to that described above in FIGS. 1-15, with the exception that the door 18 may include a mechanism for keeping it in an open position. For example, the door may include a hinge plate 70 that receives a fastener or pin 54 that allows rotation of the door relative to the fascia.

In one embodiment the hinge plate 70 includes a slot 84 that receives a pin 54. In one position of use the pin 54 is positioned in the slot 84 such that the door 18 is capable of free rotation. In a second position of use the pin 54 is positioned in the slot 84 such that the door 18 is placed adjacent to the top panel 22 of the box 10 to prevent closure of the door 18. Alternatively, one skilled in the art will appreciate that the door 18 may be interconnected to a bottom portion of a fascia 14 such that it opens downwardly.

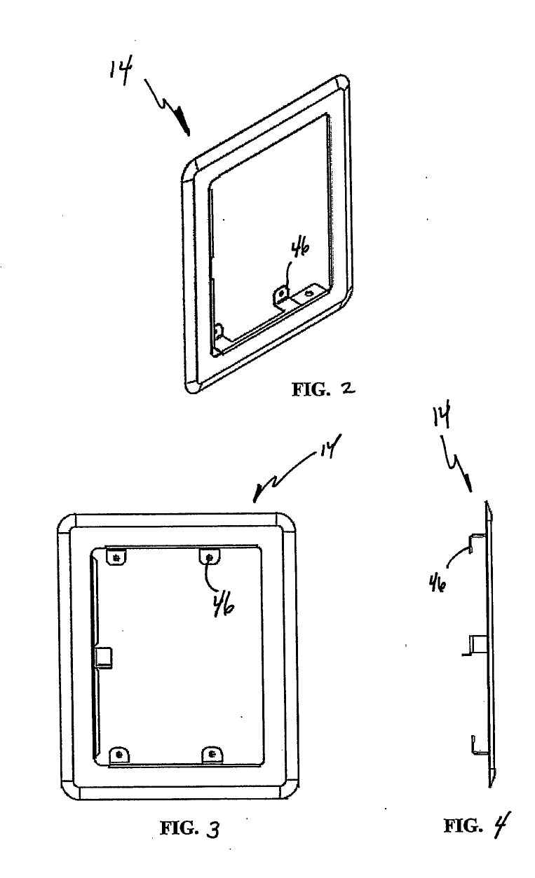

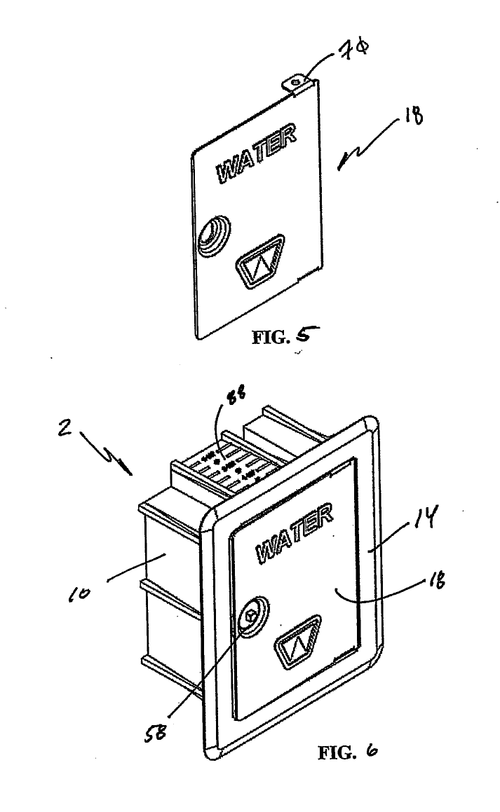

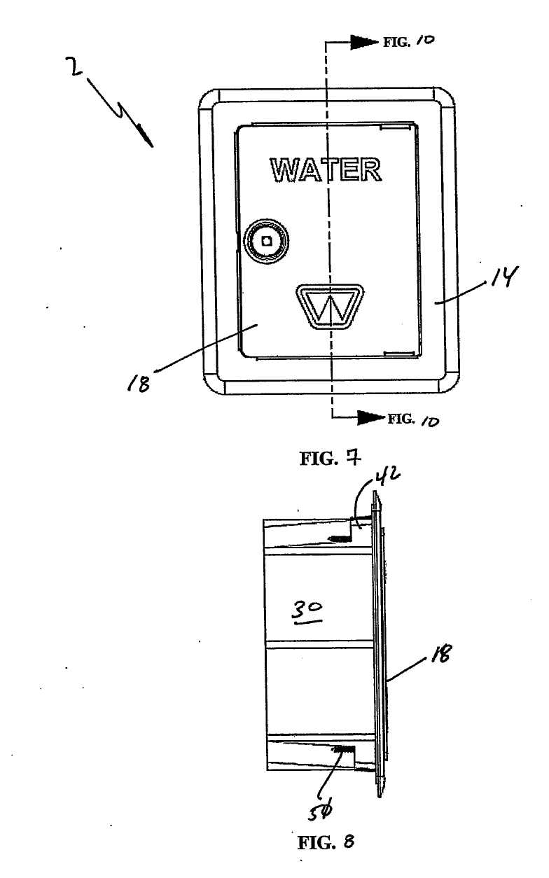

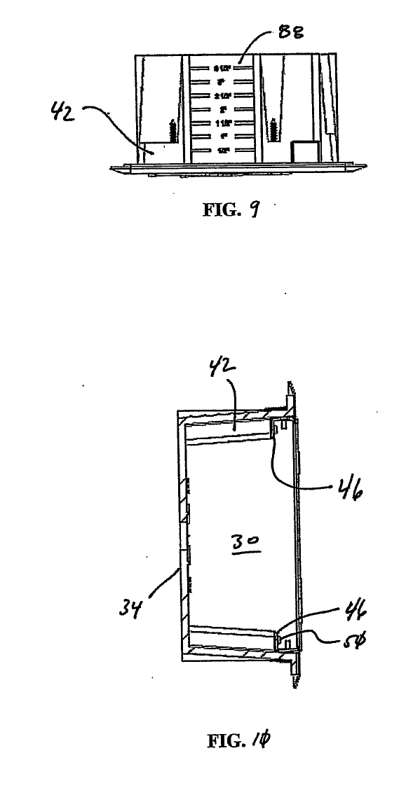

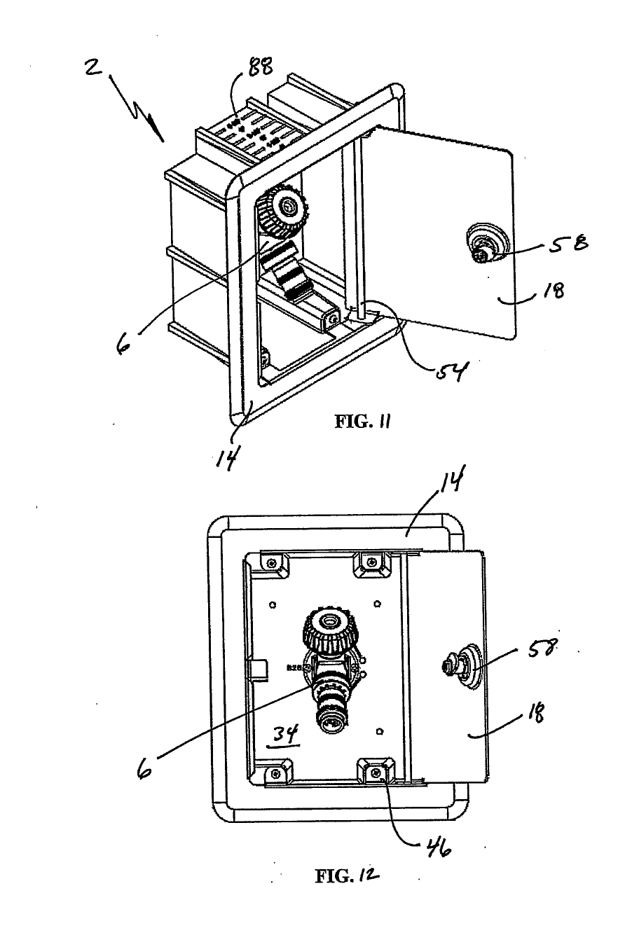

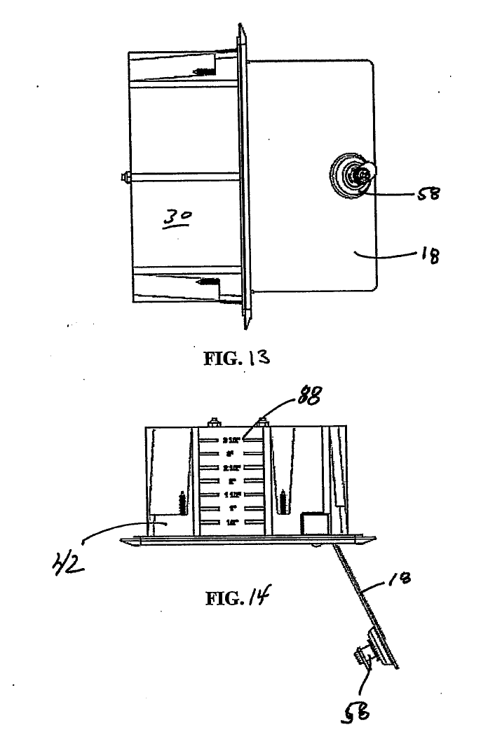

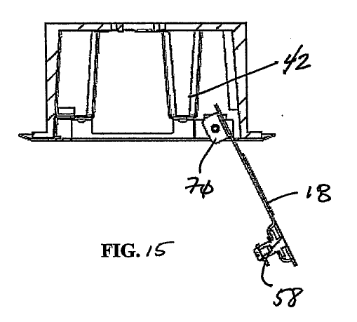

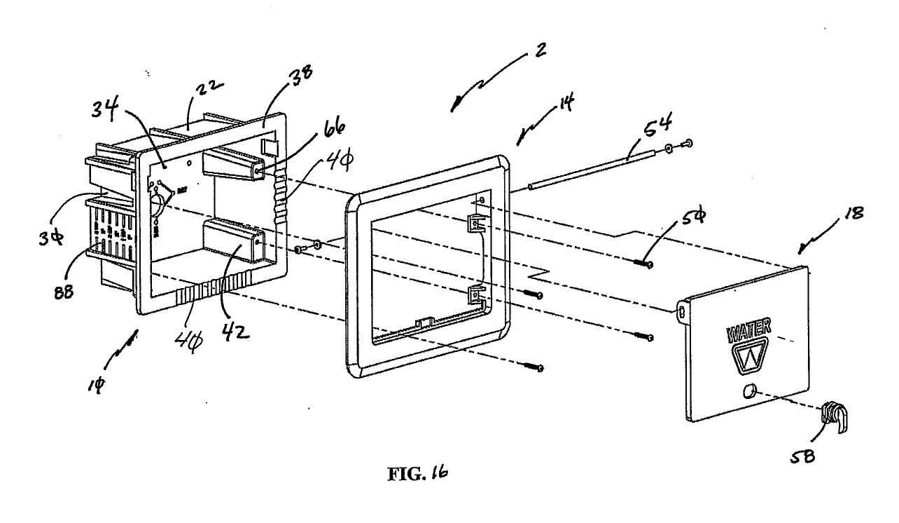

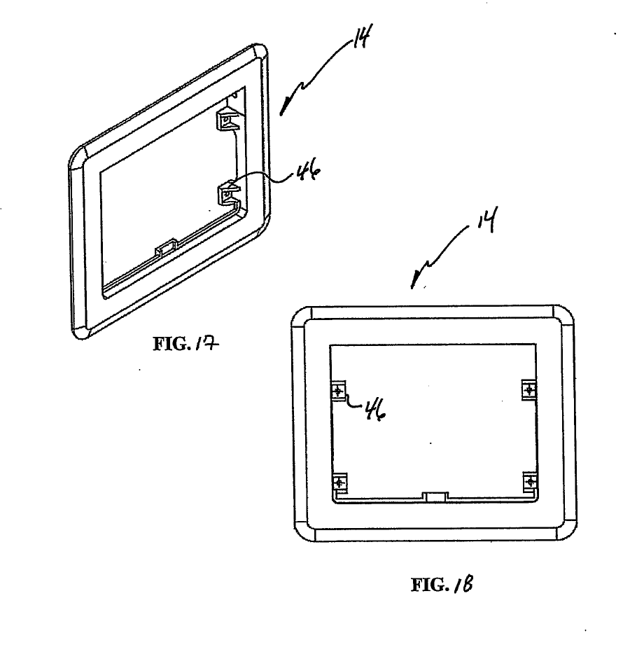

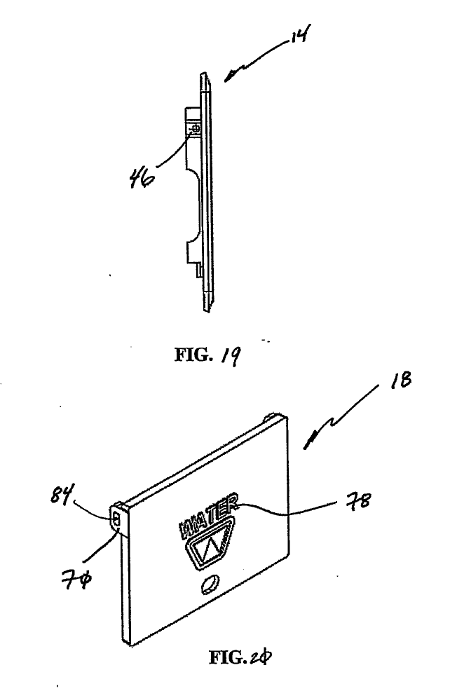

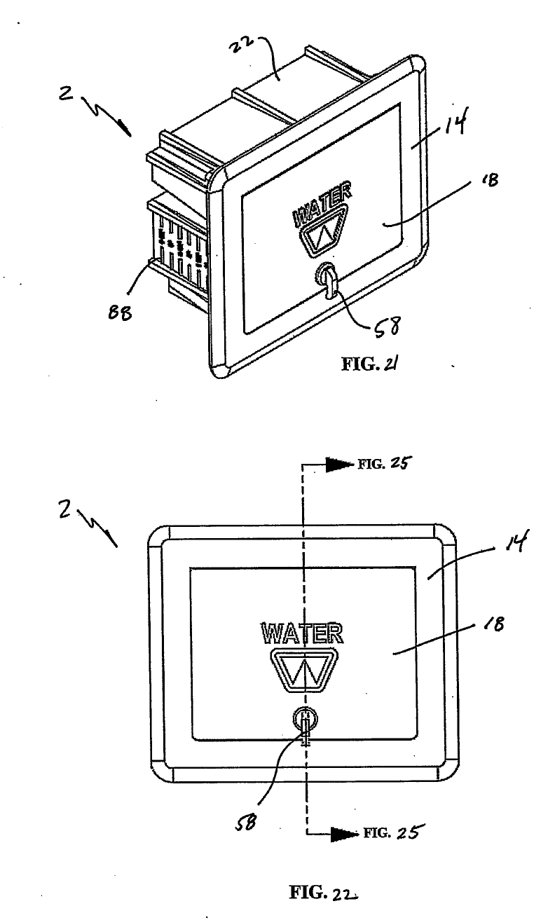

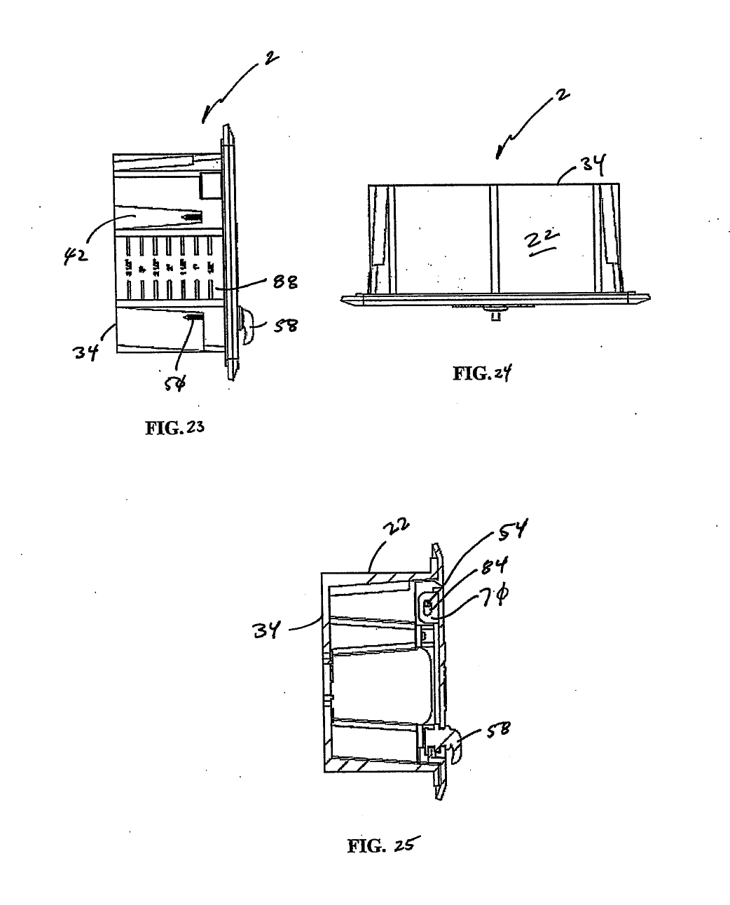

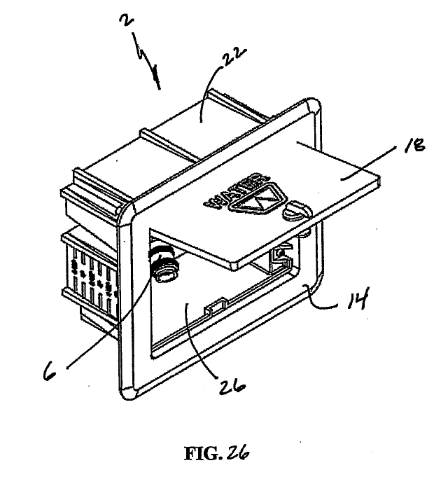

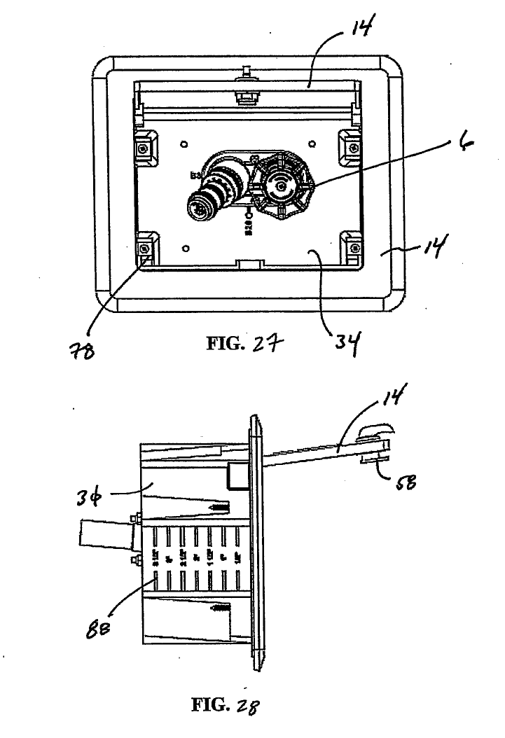

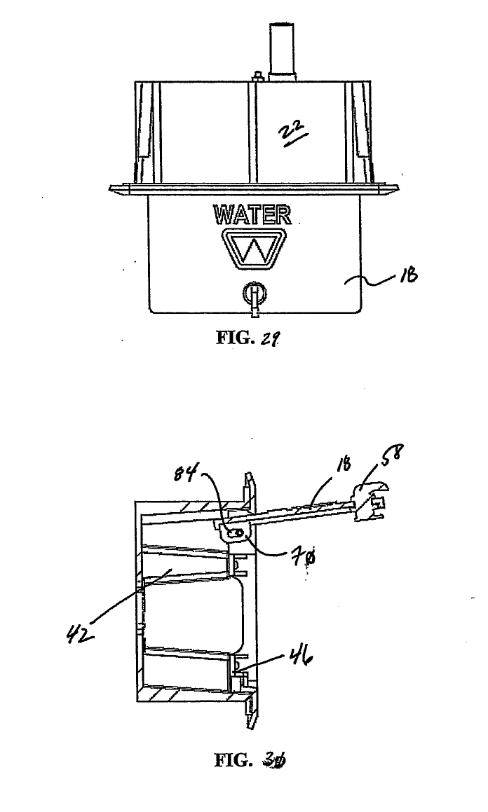

Referring now again to FIGS. 1-30, the box 10 of embodiments of the present invention is preferably made of steel, brass, aluminum, polycarbonate, polyvinyl chloride, acrylonitrile butadiene styrene, or similar materials. One skilled in the art will appreciate that other rigid materials may be employed without departing from the scope of the invention. The advantages of using these materials is that they are easily moldable to fit standard box cutouts used in construction. The fascia 14 and/or door 18 may also be made of the same or different materials that were described above, such as metal, plastic, etc. For example the fascia shown in FIGS. 2-4 is made of metal and the fascia of FIGS. 17 and 18 is made of molded plastic. The door may be made of a material that is adapted to receive indicia embossed or painted thereon. The top panel 22, the bottom panel 26 and/or the side panels 30 may also include structures, i.e. protrusions, that help orient the box 10 flush to the building structure. The box 10 of one embodiment is molded wherein the structures are integrally molded into the panel or panels. The box 10 may be tapered to facilitate molding thereof.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Furthermore, aspects of inventions disclosed in U.S. Pat. Nos. D470,915 and D482,431 and Published Patent Application No. 20040194295 are incorporated by reference herein. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. An enclosure for concealing a hydrant, comprising:
an enclosure having a top panel, a bottom panel, a left panel, a right panel, a back panel and a lip extending from and edge of said enclosure;
a fascia with an opening therethrough selectively associated with said lip; and
a closure member hingedly interconnected to said fascia.

2. The enclosure of claim 1, wherein said closure member includes a lock.

3. The enclosure of claim 1, wherein said fascia is interconnected to said enclosure via plurality of screws.

4. The enclosure of claim 1, wherein said opening has a top edge, a bottom edge, a left edge and a right edge and said closure member is hingedly interconnected to at least one of said left edge and said right edge of said opening.

5. The enclosure of claim 1, wherein said opening has a top edge, a bottom edge, a left edge and a right edge and said closure member is hingedly interconnected to at least one of said top edge and said bottom edge of said opening.

6. An enclosure for concealing a hydrant, comprising:
a receptacle for enveloping the hydrant, said receptacle having an opening;
a frame for interconnection to an edge defined by said opening; and
a door operably interconnected to said frame.

7. The enclosure of claim 6, wherein said box is generally rectangular with a depth that accommodates the hydrant.

8. The enclosure of claim 6, further comprising a lip extending from said edge wherein said lip receives said frame.

9. The enclosure of claim 8, wherein said box is adapted to be incorporated into a wall such that said lip contacts an outer surface of the wall.

10. The enclosure of claim 6, wherein said door includes a lock.

11. The enclosure of claim 6, wherein said door is hingedly interconnected to a left edge of an opening in said frame.

12. The enclosure of claim 6, wherein said door is hingedly interconnected to at least one of a top edge and a bottom edge of an opening in said frame.

13. A system for providing access to a hydrant, comprising:
a box defined by a top panel, a bottom panel, with opposing side panels positioned therebetween, and a rear panel, said panels having a lip extending from an edge of said top panel, said bottom panel, and said opposing side panels opposite from said rear panel;
a fascia with an opening therethrough associated with said lip;
a door hingedly interconnected to said fascia; and
a hydrant interconnected to said rear panel of said box, wherein said rear panel has a means for connecting with said hydrant.

14. The enclosure of claim 13, wherein said door includes a lock.

15. The enclosure of claim 13 wherein said hydrant includes a first knob associated with the delivery of cold water and a second knob associated with the delivery of hot water.

16. An enclosure for concealing and protecting a hydrant including a box defined by a top panel, bottom panel, side panels and a rear panel, wherein said top, bottom and side panels include an edge with an interconnected lip, the improvement comprising:
a fascia that is adapted to selectively engage said lip;
a door selectively interconnected to said fascia; and
wherein said fascia is removably associated with said box such that replacement of said door does not require removal of said box from a wall to which it is interconnected.

17. The enclosure of claim 16 wherein said fascia is interconnected to said box by a plurality of screws.

18. The enclosure of claim 16 wherein said door further includes a lock that cooperates with said fascia to lock the door with respect to the box.

19. A hydrant enclosure, comprising:
a housing having sides and a rearward portion, said rearward portion having an aperture sized to accept a pipe adapted for connection with a hydrant, said sides each having a length and width and an exterior surface and an interior surface, with at least one supporting structure associated on each of said sides, said at least one supporting structure extending from said rearward portion along the width of each side;
a faceplate adapted to reversibly connect to said housing, said faceplate having an aperture sized to permit an adult human hand to pass therethrough;
a cover operably associated with said faceplate, said cover being movable from a first closed position to a second open position, whereby when in said second open position, a human hand can access a hydrant positioned inside said enclosure; and
depth indicia provided on at least one of said sides.

20. The hydrant enclosure of claim 19, wherein said at least one support structure is comprised of a polygonal structure provided on said interior surface of at least two of said sides, said polygonal structure having an outward surface with an aperture adapted to receive a screw.

21. The hydrant enclosure of claim 19, wherein said movable cover comprises a door having a hinge operatively associated with said faceplate.
